(19) United States
(12) Patent Application Publication
(10) Pub. No.: US 2008/0024668 A1
(43) Pub. Date: Jan. 31, 2008

(54) Method, apparatus, and computer product for eliminating noise

(75) Inventors: Ritsuko Tanaka, Kawasaki (JP); Takashi Hamano, Kawasaki (JP)

Correspondence Address: KATTEN MUCHIN ROSENMAN LLP, 575 MADISON AVENUE, NEW YORK, NY, 10022-2585, US

(73) Assignee: Fujitsu Limited

(21) Appl. No.: 11/646,858

(22) Filed: Dec. 28, 2006

(30) Foreign Application Priority Data
Jul. 31, 2006 (JP) 2006-209176

(51) Int. Cl. H04N 5/00

(52) U.S. Cl. 348/607

(57) ABSTRACT

A film determining unit determines whether input image data are originated from a film source. A controller determines a strength at which noise is to be eliminated from the image data based on the result of determination made by the film determining unit. A noise eliminating unit eliminates noise from the image data based on the strength determined by the controller. Specifically, when image data are originated from film-recorded images, the noise elimination strength is decreased so that film grains included in the image data are preserved.

### BACKGROUND OF THE INVENTION

1. Field of the Invention

The present invention relates to a technology for eliminating noise from image data.

2. Description of the Related Art

A technique of image-quality enhancement, such as interlace/progressive (I/P) conversion, is generally used for displaying images on a display device, such as a liquid crystal television. FIG. 9 is an example of a noise eliminating apparatus 100 that performs the I/P conversion.

The noise eliminating apparatus 100 receives image data, performs an image-quality enhancement process, such as a noise elimination process, on the image data, and outputs the processed image data. The noise eliminating apparatus 100 includes an image receiving unit 101, a noise eliminating unit 102, a storage unit 103, a film determining unit 104, an I/P converter 105, and an image output unit 106. The image receiving unit 101 receives image data from an image receiver (not shown) or the like. The noise eliminating unit 102 performs a noise elimination process on the input image data. The storage unit 103 temporarily stores therein the image data having been subjected to the noise elimination process. The film determining unit 104 detects a pattern (a 2:3 pulldown or 2:2 pulldown pattern) specific to image data originated from a film source (film-recorded images) such as a movie. The I/P converter 105 performs an I/P conversion process based on the pattern of the pulled-down film source determined by the film determining unit 104. The image output-unit 106 outputs the image data having been subjected to the I/P conversion process. The I/P converter 105 includes a film I/P converter 105a that performs an I/P conversion process on image data originated from a film source, and a general I/P converter 105b that performs an I/P conversion process on image data originated from a source other than a film.

In general, digital signal processing, such as the I/P conversion, is highly susceptible to noise. Therefore, as shown in FIG. 9, prior to performing the I/P conversion in the I/P converter 105, the input image data are subjected to the noise elimination process performed in the noise eliminating unit 102. Because the image data is subjected to the noise elimination process, noiseless, sharp, and clear images can be displayed, thereby significantly enhancing image quality.

In the I/P converter 105, the film I/P converter 105a performs an I/P conversion process on the input image data when the film determining unit 104 determines that the image data from which noise is eliminated has originated from a film source. On the other hand, the general I/P converter 105b performs an I/P conversion process on the image data when the film determining unit 104 determines that the image data has not originated from a film source.

Moreover, demands for placing importance on the “texture” of a picture (image), such as film grains (FG) (grains specific to a film), intentionally included by an image producer as in the case of, for example, a film-recorded movie, are increasing. The noise elimination process, however, has an adverse effect of imparting unnecessarily plain impression to images of a movie or the like. Therefore, various techniques have been proposed to preserve film grains included in film images.

For example, according to Japanese Patent Application Laid-Open No. 2004-336705, as shown in FIG. 10, image data input to a noise eliminating apparatus 200 are processed as follows. Image data sets obtained before and after performing a noise elimination process on the input image data are respectively stored in storage units (FIG. 10 depicts an example in which the two image data sets are stored in storage units 203a and 203b, respectively). Images to be displayed are switched such that, when the input images are those originated from a film source (data on film-recorded images such as a movie), images before being subjected to the noise elimination process with film grains preserved, are displayed on a display device, while when the input images are originated from a source other than a film, images from which noise is eliminated are displayed.

According to Japanese Patent Application Laid-Open No. 2005-80301, as shown in FIG. 11, a noise eliminating apparatus 300 further includes an FG component detector 307, a delay-adjustment storage unit 308, an FG I/P converter 309, and a superimposing unit 310. The FG component detector 307 detects a film grain component included in input images, and encodes its representative pattern. When the input images are originated from a film source, the FG I/P converter 309 decodes the representative pattern of the film grain component acquired by way of the delay-adjustment storage unit 308. The superimposing unit 301 superimposes the thus-decoded representative pattern of the film grain component on the image data from which noise is eliminated.

According to the technique described in Japanese Patent Application Laid-Open No. 2004-336705, image data sets before and after being subjected to the noise elimination process are respectively stored in the memories, so that the number of the storage units or the capacity of the storage units must be increased, which disadvantageously increases the hardware scale.

Because the technique described in Japanese Patent Application Laid-Open No. 2005-80301 uses a representative pattern of film grains, images completely preserving film grains having been included in input images cannot be displayed. Furthermore, because this technique requires the functions of detecting film grains and superimposing film grains onto images from which noise is eliminated, the hardware scale disadvantageously increases.

The increase of the hardware scale can lead to other problems, such as broadening of the area of an integrated circuit chip that implements the image quality enhancement and an increase of power consumption.

Thus, there is a need of a technology that can preserve the texture of film images with a simple and compact configuration.

### SUMMARY OF THE INVENTION

It is an object of the present invention to at least partially solve the problems in the conventional technology.

According to an aspect of the present invention, a noise eliminating apparatus that eliminates noise from input image data includes a film determining unit that determines whether the image data are originated from film recording; a strength determining unit that determines a strength at which noise is to be eliminated from the image data based on a result of determination made by the film determining unit; and a noise eliminating unit that eliminates noise from the image data based on the strength determined by the strength determining unit.

According to another aspect of the present invention, a method of eliminating noise from input image data includes first determining including determining whether the image data are originated from film recording; second determining including determining a strength at which noise is to be eliminated from the image data based on a result of determination made at the determining; and eliminating noise from the image data based on the strength determined at the determining.

According to still another aspect of the present invention, a computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a noise eliminating apparatus according to a first embodiment of the present invention;

FIG. 2 is a flowchart of a process procedure performed by the noise eliminating apparatus shown in FIG. 1;

FIG. 3 is a graph for explaining changes in a noise elimination strength according to a second embodiment of the present invention;

FIG. 4 and FIG. 5 are graphs for explaining changes in a noise elimination strength according to a third embodiment of the present invention;

FIG. 6 is an example of an operation screen according to a fourth embodiment of the present invention;

FIG. 7 is a flowchart of a process procedure performed by a setting information managing unit with regard to the operation screen according to the fourth embodiment;

FIG. 8 is a block diagram of a computer that executes a noise-elimination control program according to the first embodiment to the fourth embodiment; and

FIG. 9 to FIG. 11 are block diagrams of conventional noise eliminating apparatuses.

### DETAILED DESCRIPTION OF THE PREFERRED EMBODIMENTS

Exemplary embodiments of the present invention will be explained in detail below with reference to the accompanying drawings. The present invention is not limited to the embodiments.

A noise eliminating apparatus according to a first embodiment of the present invention receives image data from an image receiver or the like, performs an image-quality enhancement process, such as noise elimination and I/P conversion, on the input image data, and outputs the processed image data on a display device. The noise eliminating apparatus checks the input image data as required, and determines whether the input image data are originated from a film source. When the input image data are determined to be originated from a film source, the noise eliminating apparatus outputs the input image data without performing the image-quality enhancement process on the image data, so that film grains in the image are not destroyed.

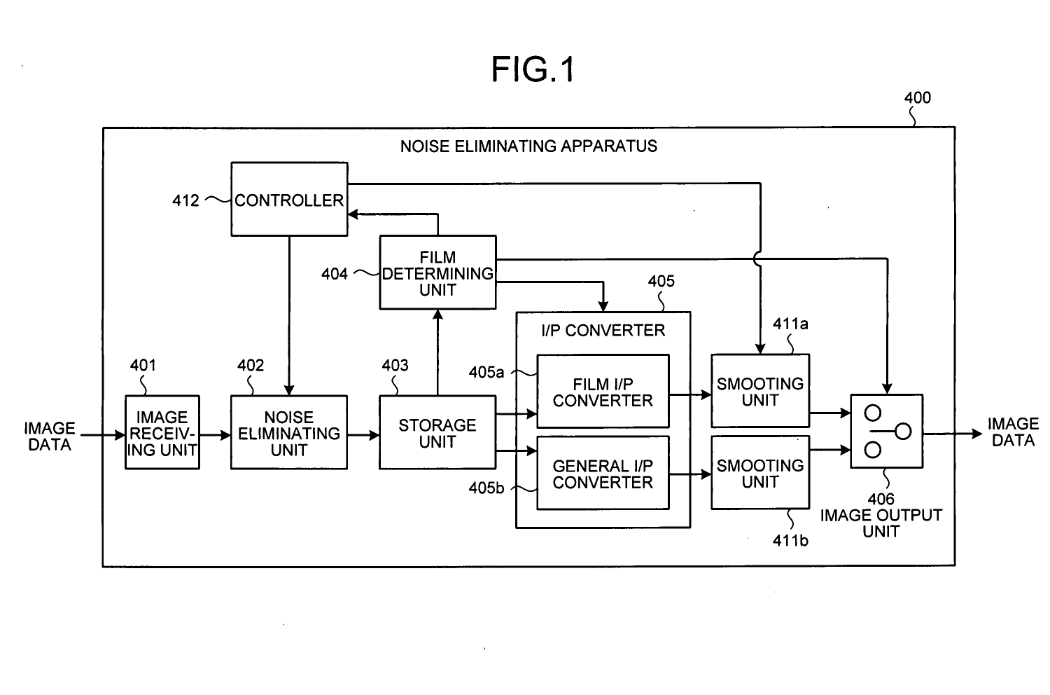

FIG. 1 is a block diagram of a noise eliminating apparatus 400 according to the first embodiment. The noise eliminating apparatus 400 includes an image receiving unit 401, a noise eliminating unit 402, a storage unit 403, a film determining unit 404, an I/P converter 405, an image output unit 406, two smoothing units 411a and 411b, and a controller 412.

The image receiving unit 401 receives image data from an image receiver (not shown) or the like. The image receiving unit 401 receives

(i) image data originated from a film source (film-recorded images), or

(ii) a video source (obtained according to the national television standards committee (NTSC)) system, or

(iiI) image data which is video-recorded in a high definition television format.

The noise eliminating unit 402 performs a noise elimination process on the input image data. Specifically, the noise eliminating unit 402 detects a noise component included in the input image data, and removes the noise component from the input data.

The noise eliminating unit 402 decides whether to perform the noise elimination process based on an instruction issued from the controller 412. More specifically, upon receipt of an instruction to stop the noise elimination process from the controller 412, the noise eliminating unit 402 stops the noise elimination process, while upon receipt of an instruction to resume the noise elimination process, the noise eliminating unit 402 resumes the noise elimination process on the image data.

The storage unit 403 temporarily stores therein image data having been subjected to the noise elimination process by the noise eliminating unit 402.

The film determining unit 404 sequentially reads image data from the storage unit 403, and determines whether the read image data have originated from a film source. More specifically, the film determining unit 404 determines whether a pattern specific to a film source, such as a movie, is present in the read image data. For example, the film determining unit 404 detects whether a pattern converted according to 2:3 pulldown scheme is present in the read image data.

The 2:3 pulldown scheme is a conversion scheme of converting image data originated from a 24-frames-per-second film source into 60-frames-per-second image data of an interlace scan format. The conversion is performed so that the image data are sequentially displayed in the form of two fields of one frame, which are followed by three fields of the next frame, two fields of the subsequent frame, three fields of the subsequent frame, and the like.

The film determining unit 404 sequentially reads the image data from the storage unit 403, and compares successive two frames of the read image data. Upon detecting that the successive two frames are identical, the film determining unit 404 determines that the read image data are originated from a film source.

When the image data are determined to be originated from a film source, the film determining unit 404 notifies this fact to the controller 412, and simultaneously controls the image output unit 406 so as to output the image data having been subjected to a film I/P conversion process. When the image data are determined not to be originated from a film source, the film determining unit 404 notifies this fact to the controller 412, and controls the image output unit 406 so as to output the image data having been subjected to a general I/P conversion process.

The I/P converter 405 sequentially reads image data from the storage unit 403, and performs the I/P conversion process on the read image data. The I/P converter 405 includes a film I/P converter 405a and a general I/P converter 405b. The I/P conversion process is a process of converting image data of an interlace scan format into image data of a progressive scan format.

According to the interlace scan scheme, one frame is divided into a frame (odd field) that displays only odd lines among pixel lines in the frame and another frame (even field) that displays only even lines, and thereafter, 60 frames (30 odd field frames and 30 even field frames) are displayed in one second. On the other hand, according to the interlace scan scheme, 60 frames, each including all of the non-interlaced pixel lines, are displayed in one second.

Accordingly, in the I/P conversion process, missing odd and even lines are respectively interpolated to the even fields and the odd fields of the interlace scan format so as to generate 60 frames per second of the progressive scan format. The interpolation process for still pictures differs from that for motion pictures. In the process for still pictures, lines of a field prior to the processed field are interpolated. In the process for motion pictures, new lines are generated based on pixels on the upper and lower lines in the same field as the processed field, thereby interpolating the lines.

The film I/P converter 405a sequentially reads image data from the storage unit 403, and performs an I/P conversion process that is appropriate for image data originated from a film source on the read image data. When image data originated from a film source are directly subjected to the I/P conversion process, the image data maybe deteriorated in image quality or can include jerky motions. The reason for these problems is described below. In image data originated from a film source, two frames of a single image and three frames of the subsequent image are alternately repeated. Therefore, when the I/P conversion process of a frame is performed by simply interpolating lines included in a field prior to the converted field, a patched frame that is interpolated with lines having originally been included in another frame is obtained. Therefore, the film I/P converter 405a temporarily inverses the read image data back to the original 24-frames-per-second data, and thereafter converts the image data into 60-frames-per-second data of the progressive scan format.

The general I/P converter 405b sequentially reads image data from the storage unit 403, and performs an I/P conversion process appropriate for image data originated from a source other than a film on the read image data. The general I/P converter 405b interpolates lines to the image data having been read from the storage unit 403 as previously described, thereby converting the image data into frames of the progressive scan format.

Each of the smoothing units 411a and 411b performs a smoothing process on the image data having been subjected to an I/P conversion process performed by a corresponding one of the film I/P converter 405a and the general I/P converter 405b. Examples of the smoothing process include, but not limited to, a process of adjusting contrasts between bright areas and dark areas in an image as required, and a process of smoothing color tone variations of a specific image such as an image of a person's face.

When the image data that are originated from a film source are subjected to the smoothing process, film grains included in the image data maybe disadvantageously lost. Therefore, the smoothing unit 411a performs or does not perform the smoothing process based on an instruction issued from the controller 412. More specifically, upon receipt of an instruction to stop the smoothing process from the controller 412, the smoothing unit 411a stops the smoothing process on the image data, while the smoothing unit 411a resumes the smoothing process on the image data upon receipt of an instruction to resume the smoothing process.

The image output unit 406 outputs image data having been subjected to the respective processes to a display device or the like. When an instruction to output image data originated from a film source is issued from the controller 412, the image output unit 406 outputs image data having been subjected to the smoothing process performed by the smoothing unit 411a. When an instruction to output image data originated from a source other than a film is issued from the controller 412, the image output unit 406 outputs image data having been subjected to the smoothing process performed by the smoothing unit 411b.

The controller 412 controls whether to perform the noise elimination process on the input image data. More specifically, when the controller 412 receives a notification from the film determining unit 404 that image data originated from a film source have been input, the controller 412 instructs the noise eliminating unit 402 to stop the noise elimination process and instructs the smoothing unit 411a to stop the smoothing process, and instructs the image output unit 406 to output the image data.

On the other hand, when the controller 412 receives a notification from the film determining unit 404 that image data originated from a source other than a film have been input, the controller 412 instructs the noise eliminating unit 402 to resume the noise elimination process and the smoothing unit 411a to resume the smoothing process, and instructs the image output unit 406 to output image data having been subjected to the processes.

As described above, when input image data are determined not to be originated from a film source, the controller 412 resumes the noise elimination process on the image data, and when input image data are determined to be originated from a film source, the controller 412 stops the noise elimination process on the image data. Therefore, it is possible to eliminate noise from image data originated from a source other than a film to thus enhance its image quality, while not to eliminate noise from image data on film-recorded images to thus preserve film grains. Hence, image quality enhancement and film grain preservation can be switched adaptively according to the type of image data.

In the present embodiment, the controller 412 controls the noise eliminating unit 402 and the smoothing unit 411a based on a result of determination made by the film determining unit 404 as to whether the image data are originated from a film source. Alternatively, the controller 412 can control the noise eliminating unit 402 and the smoothing unit 411a based on a result of film source determination input from the outside of the noise eliminating apparatus 400 or the like.

In the present embodiment, an example in which the controller 412 controls the noise eliminating unit 402 and the smoothing unit 411a has been explained. Alternatively, the controller 412 need not control the noise eliminating unit 402, but can control one or more other processes that can eliminate film grains as in the noise elimination process.

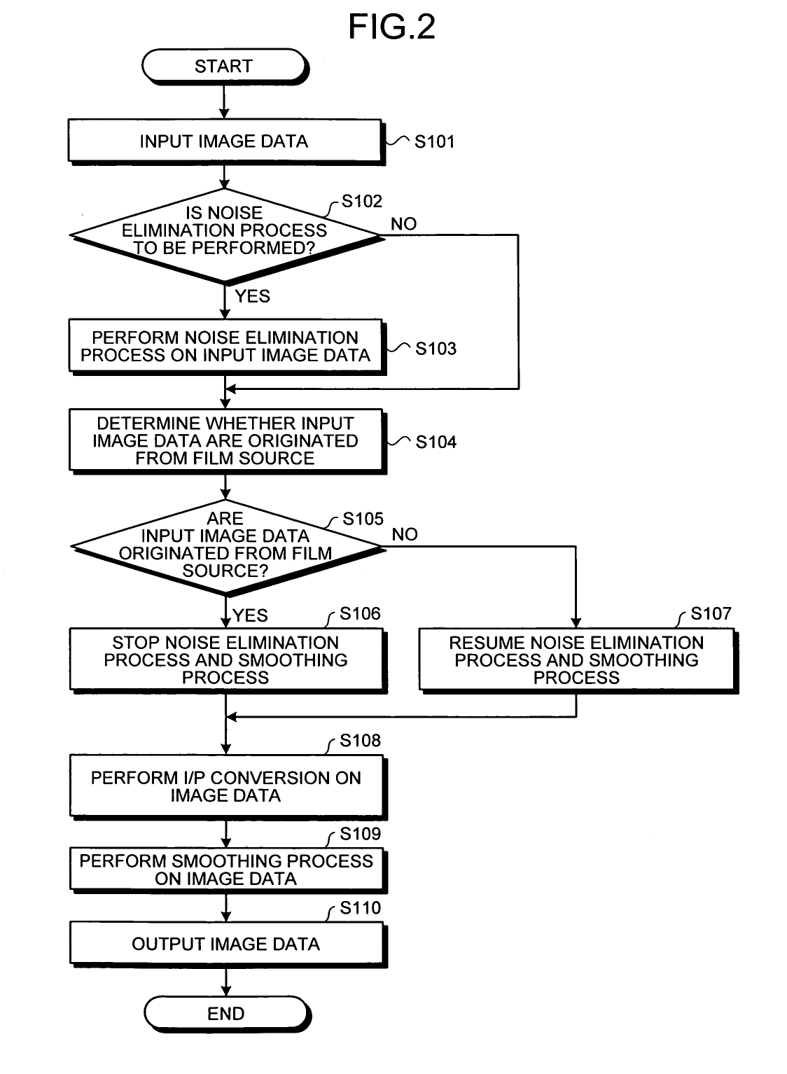

A process procedure performed by the noise eliminating apparatus 400 will be described. FIG. 2 is a flowchart of the process procedure performed by the noise eliminating apparatus 400. As shown in FIG. 2, the image receiving unit 401 receives image data (step S101). When the noise eliminating unit 402 receives an instruction from the controller 412 to perform the noise elimination process (YES at step S102), the noise eliminating unit 402 performs the noise elimination process on the input image data (step S103). The processed image data are stored in the storage unit 403. On the other hand, when the noise eliminating unit 402 receives an instruction from the controller 412 to not perform the noise elimination process (NO at step S102), the noise eliminating unit 402 does not perform the noise elimination process, and stores the input image data as it is in the storage unit 403.

The film determining unit 404 then sequentially reads the image data from the storage unit 403, and determines whether the input image data are originated from a film source (step S104).

When the film determining unit 404 determines that the read image data are originated from a film source (YES at step S105), the noise eliminating unit 402 stops the noise elimination process according to an instruction issued from the controller 412, and the smoothing unit 411a stops the smoothing process (step S106).

On the other hand, when the film determining unit 404 determines that the image data are originated from a film source (NO at step S105), the noise eliminating unit 402 resumes the noise elimination process according to an instruction issued from the controller 412, and the smoothing unit 411a resumes the smoothing process (step S107).

While the control operations over the noise elimination process and the smoothing process are performed, each of the film I/P converter 405a and the general I/P converter 405b reads the image data from the storage unit 403, and performs an I/P conversion process on the read image data (step S108). Further, the smoothing units 411a and 411b respectively perform the smoothing process on the corresponding image data (step S109).

The image output unit 406 outputs image data having been subjected to the respective processes from one of the smoothing units 411a and 411b according to an instruction issued from the controller 412 to the display device and the like (step S110).

In the first embodiment, noise elimination process is performed before determining whether the input image data are originated from a film source. Alternatively, it is possible to determine whether the input image data are originated from a film source before performing the noise elimination process. In this configuration, the noise elimination process is performed such that image data stored in the storage unit 403 are sequentially read, and subjected to the noise elimination process. In each configuration, the controller 412 controls the noise eliminating unit 402 based on the result of determination made by the film determining unit 404.

As described above, in the first embodiment, the film determining unit 404 determines whether the input image data are originated from a film source, the controller 412 determines a strength at which noise is to be eliminated from the image data based on the result of determination made by the film determining unit 404, and the noise eliminating unit 402 eliminates noise from the image data according to the strength determined by the controller 412. Accordingly, when the image data are those on film-recorded images, the noise elimination strength is decreased, thereby enabling preservation of film grains included in the image data, without increasing the capacity of a memory for retaining respective image data of before and after being subjected to a noise elimination process and without addition of special functions of superimposing film grains on image data from which noise is eliminated. Hence, texture of film images can be preserved with a simple functional structure without excessively increasing the hardware scale.

According to the first embodiment, when input image data are determined to be originated from a film source, the noise elimination process is not performed, thereby preserving film grains. Alternatively, the noise elimination strength can be decreased appropriately so as to preserve film grains while eliminating noise by an appropriate amount rather than completely stopping the noise elimination process.

In a second embodiment of the present invention, an example in which input image data are determined to be originated from a film source is explained. An example in which the noise eliminating unit 402 shown in FIG. 1 changes the noise elimination strength, and the controller 412 controls the noise eliminating unit 402 is described, and descriptions about other functional units shown in FIG. 1 will be omitted.

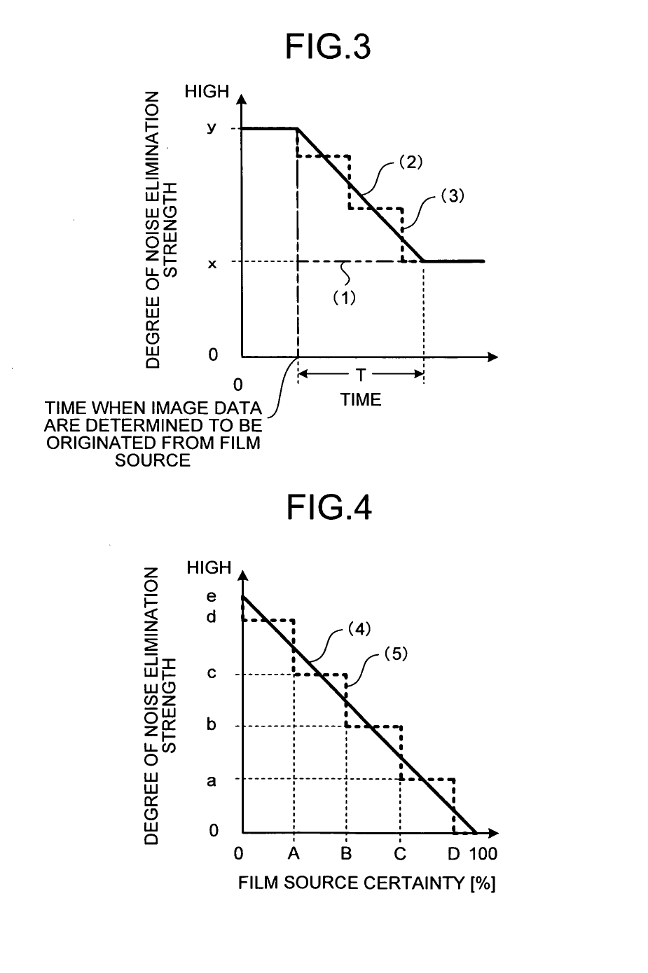

FIG. 3 is a graph for explaining how the noise elimination strength is varied in the second embodiment. In FIG. 3, a vertical axis represents the noise elimination strength, and a horizontal axis represents time. Each “x” and “y” in FIG. 3 is a value that indicates noise elimination strength (x<y).

Upon receipt of a notification from the film determining unit 404 that image data originated from a film source have been input, the controller 412 instructs the noise eliminating unit 402 to change the noise elimination strength, and simultaneously transmits a value that indicates a predetermined target strength to the noise eliminating unit 402. For example, the controller 412 transmits the value “x” shown in FIG. 3 to the noise eliminating unit 402.

Upon receipt of the instruction from the controller 412 to change the noise elimination strength, the noise eliminating unit 402 changes the noise elimination strength based on the value on strength transmitted from the controller 412 together with the instruction. For example, upon receipt of the value “x” transmitted from the controller 412 as the strength, the noise eliminating unit 402 changes the noise elimination strength from “y” to “x” as indicated by (1) in FIG. 3.

Alternatively, the controller 412 can transmit to the noise eliminating unit 402 a predetermined target strength and a predetermined setting-changing time together with an instruction to change the noise elimination strength. Upon receipt of the instruction and the values, the noise eliminating unit 402 can change the noise elimination strength to the target strength gradually or stepwise over the predetermined setting-changing time. For example, the noise eliminating unit 402 changes the noise elimination strength continuously from “x” to “y” over a setting-changing time “T” as indicated by (2) in FIG. 3, or stepwise as indicated by (3) in FIG. 3.

As described above, in changing the strength at which noise is to be eliminated from image data, the controller 412 changes the strength gradually from a strength of before being changed to a target strength over a predetermined setting-changing time. Hence, sudden changes in image quality are prevented, thereby decreasing, jerky changes in image quality.

As described above, in the second embodiment, when input image data are determined not to be originated from a film source, the controller 412 sets the strength with which noise is to be eliminated from the image data to a first strength (e.g., “x” in FIG. 3), while when the image data are determined to be originated from a film source, the controller 412 sets the strength with which noise is eliminated from the image data to a second strength (e.g., “y” in FIG. 3), which is lower than the first strength. Accordingly, by adjusting the second strength, film grains can be preserved while simultaneously eliminating a portion of noise. In addition, by setting the second strength so as not to be greatly higher than the first strength, a certain amount of film-grains can be preserved without emphasizing the difference from image data from which noise is completely eliminated.

According to the first embodiment and the second embodiment, when input image data are determined to be originated from a film source, the noise elimination strength is immediately changed. Alternatively, when the result of film source determination fluctuates within a predetermined period of time (hereinafter, “preset response time”), it is possible not to perform control over the noise elimination process. More specifically, the controller 412 shown in FIG. 1 holds the result of film source determination notified from the film determining unit 404, while when the result of determination does not fluctuate within the preset response time, the controller 412 instructs the noise eliminating unit 402 to stop the noise elimination process.

As described above, when the result of determination does not fluctuate within a lapse of a certain preset response time, the film determining unit 404 determines the strength with which noise is to be eliminated from the image data based on the result of determination. Therefore, when the result of determination on image data fluctuates within a short period of time, frequent changes in image quality are prevented, thereby decreasing jerky changes in image quality.

In the second embodiment, an example in which the noise elimination strength is changed according to the result of the determination as to whether input image data are originated from a film source has been explained. Alternatively, in making a determination as to whether the input image data are originated from a film source, a certainty of the image data being originated from a film source can be calculated, and the noise elimination strength can be changed according to the certainty.

In a third embodiment of the present invention, an example in which the noise elimination strength is changed according to the certainty of the input image data being originated from a film source is explained. An example in which the film determining unit 404 calculates the film source certainty, the noise eliminating unit 402 changes the noise elimination strength, and the controller 412 controls the film determining unit 404 and the noise eliminating unit 402 is described, and descriptions on other functional units shown in FIG. 1 will be omitted.

The film determining unit 404 sequentially reads image data from the storage unit 403, compares successive two frames of the image data, and calculates the certainty of the two frames being identical. For example, the film determining unit 404 compares pixels included in a frame with pixels in the other frame to be compared therewith for every pixel, and calculates a ratio of the number of coinciding pixels to the total number of pixels in one frame as the certainty. The film determining unit 404 transmits the thus-calculated certainty to the controller 412 as a result of film source determination.

Upon receipt of the film source certainty notified from the film determining unit 404, the controller 412 determines the noise elimination strength based on the notified certainty, instructs the noise eliminating unit 402 to change the noise elimination strength, and simultaneously transmits the thus-determined strength to the noise eliminating unit 402.

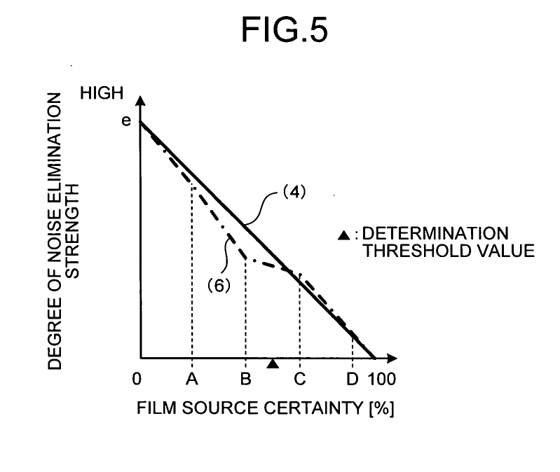

FIG. 4 and FIG. 5 are graphs for explaining how the noise elimination strength is varied in the third embodiment. In FIG. 4 and FIG. 5, the vertical axis represents the noise elimination strength, and the horizontal axis represents the film source certainty. In FIG. 4 and FIG. 5, “a”, “b”, “c”, “d”, and “e” denote values each representing the noise elimination strength (0<a<b<c<d<e) ; and “A”, “B”, “C”, “D”, and “E” denote values each representing a film source certainty (0[%]<A<B<C<D<100[%]).

For example, as indicated by (4) in FIG. 4, the controller 412 sets the noise elimination strengths to “e” and “0” for the film source certainties of 0% and 100%, respectively, and determines the noise elimination strength so that the strength continuously decreases as the film source certainty increases.

Alternatively, the controller 412 can determine the noise elimination strength as indicated by (5) in FIG. 4 so that the strength decreases stepwise to take the values of “e”, “d”, “c”, “b”, “a”, and “0” in this order as the film source certainty increases taking the values of “0”, “A”, “B”, “C”, “D”, and “100” in this order.

Further alternatively, the controller 412 can set a predetermined threshold value for the film source certainty (hereinafter, “determination threshold value”), and determine the noise elimination strength so that a change rate is reduced near the determination threshold value. For example, when the determination threshold value is set to a value between the values “B” and “C” as indicated by (6) in FIG. 5, the noise eliminating unit 402 determines the noise elimination strength so that the change rate within the range from “B” to “C” is more moderate than that in the other ranges.

The correlation between the noise elimination strength and the certainty is stored as setting information in, for example, a storage unit (not shown in FIG. 1).

As described above, a region of the certainty is divided into a high-certainty region, a low-certainty region, and a medium-certainty region that is a region between the high-certainty and the low-certainty regions. The controller 412 determines the second strength based on setting information having been set so that the change rate of the noise elimination strength in the medium-certainty region is lower than that in the high-certainty region and that in the low-certainty region. Accordingly, it is possible to control image data so as to have small changes in image quality within a range where a definite determination as to whether the image data are originated from a film-recorded source is difficult to make, thereby decreasing jerky changes in image quality.

Upon receipt of the instruction from the controller 412 to change the noise elimination strength, the noise eliminating unit 402 changes the noise elimination strength based on the value of the strength transmitted from the controller 412 together with the instruction.

As described above, in the third embodiment, the film determining unit 404 calculates the certainty that indicates a possibility of input image data being originated from a film source, and the controller 412 sets the noise elimination strength for image data originated from a film source based on the certainty calculated by the film determining unit 404. Accordingly, even when there is an error in the determination as to whether image data are on film-recorded images and thus fluctuates the result of determination about the image data, it is possible to change the noise elimination strength continuously according to the fluctuation, thereby decreasing jerky changes in image quality.

The second embodiment and the third embodiment relate to changing the noise elimination strength. Alternatively, the controller 412 can change a strength with which the smoothing process is to be performed by the smoothing unit 411a shown in FIG. 1 using a similar control method.

More specifically, the controller 412 determines, based on a result of determination as to whether input image data are on film-recorded images, the smoothing strength for smoothing the image data, and smoothes the image data according to the thus-determined strength. Accordingly, when image data are film-recorded images, the strength of smoothing the image data is decreased, thereby enabling preservation of film grains included in the image data completely without addition of a special function of superimposing film grains on smoothed image data. Hence, texture of film images can be preserved with a simple functional structure without-excessively increasing the hardware scale.

The first to third embodiments have respectively described about the respective processes and controls performed by the noise eliminating unit 400 to preserve film grains. Alternatively, an operation screen can be displayed on a display device or the like, to allow a user to arbitrarily change the setting information related to the above processes and controls.

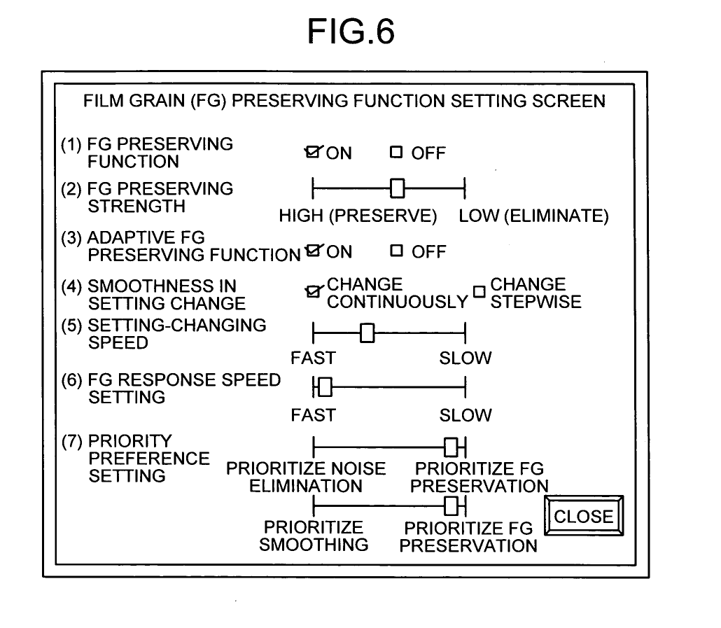

In a fourth embodiment of the present invention, an operation screen for the user to perform various settings is explained. An example in which the controller 412 shown in FIG. 1 displays the operation screen on a display device, and changes the various setting information according to input from a user is explained. FIG. 6 is an example of an operation screen according to the fourth embodiment. As shown in FIG. 6, following seven setting items can be changed with this operation screen. (1) FG preserving function, (2) FG preserving strength, (3) adaptive FG preserving function, (4) smoothness in setting change, (5) setting-changing speed, (6) FG response speed setting, and (7) priority preference setting. The respective setting items will be described below:

“(1) FG preserving function” is a setting item for the user to select whether to perform the control for preserving film grains described in the first to the third embodiments. As shown in FIG. 6, the user can select ON or OFF.

When ON is selected in (1), the controller 412 performs a control, such as stopping or resuming the noise elimination process and the smoothing process, or changing the strengths with respect to the noise elimination process and the smoothing process, based on the result of film source determination made by the film determining unit 404 to preserve film grains. On the other hand, when OFF is selected, the controller 412 does not perform the control to preserve film grains.

“(2) FG preserving strength” is a setting item for the user to set a target noise elimination strength (e.g., the value “x” shown in FIG. 4) for use in changing the noise elimination strength described in the second embodiment. As shown in FIG. 6, an arbitrary setting value within a range from “high (preserve)” to “low (eliminate)” can be set. The setting value is correlated with the noise elimination strength such that the noise elimination strength is “0” for the value set to “high (preserve)”, and the strength increases as the value approaches “low (eliminate)”.

When the controller 412 receives a notification from the film determining unit 404 that image data originated from a film source have been input, the controller 412 instructs the noise eliminating unit 402 to change the noise elimination strength, and simultaneously transmits the thus-set noise elimination strength to the noise eliminating unit 402.

“(3) Adaptive FG preserving function” is a setting item for the user to select whether to change the noise elimination strength based on the film source certainty described in the third embodiment. As shown in FIG. 6, the user can select ON or OFF.

When ON is selected in (3), the controller 412 determines the noise elimination strength based on the certainty, and controls the noise eliminating unit 402 so as to change the noise elimination strength according to the thus-determined strength. On the other hand, when OFF is selected, the controller 412 does not perform the control to change the noise elimination strength based on a certainty.

“(4) Smoothness in setting change” is a setting item for the user to select whether to change the noise elimination strength, to be performed by the noise eliminating unit 402, continuously or stepwise as described in the second and the third embodiments. As shown in FIG. 6, the user can select “change continuously” or “change stepwise”.

The controller 412 instructs the noise eliminating unit 402 to change the noise elimination strength either continuously or stepwise based on the setting value selected in the setting item (4).

“(5) Setting-changing speed” is a setting item for the user to set the setting-changing time (duration over which the noise elimination strength is to be changed continuously or stepwise (“T” indicated by (2) in FIG. 3)) described in the second embodiment. As shown in FIG. 6, an arbitrary setting value within a range from “fast” to “slow” can be set. The setting value is correlated with the length of setting-changing time such that the setting-changing time is “0” for the value set to “fast”, and the setting-changing time becomes longer as the value approaches “slow”.

The controller 412 holds the result of film source determination notified from the film determining unit 404, and instructs the noise eliminating unit 402 to change the noise elimination strength over the thus-set setting-changing time.

“(6) FG response speed setting” is a setting item for the user to set the preset response time (a predetermined period of time for controlling not to perform the noise elimination process, when a result of film source determination fluctuates within the predetermined period of time) described in the second embodiment. As shown in FIG. 6, an arbitrary setting value within a range from “fast” to “slow” can be set. The setting value is correlated with the length of a preset response time such that the preset response time is “0” for the value which is set to “fast”, and the preset response time becomes longer as the value approaches “slow”.

The controller 412 holds a result of film source determination notified from the film determining unit 404, and when the result of determination does not fluctuate within the preset response time, the controller 412 instructs the noise eliminating unit 402 to stop the noise elimination process.

“(7) Priority preference setting” is a setting item for the user to set priorities for the noise elimination process and the smoothing process. For the noise elimination process, the user can set an arbitrary setting value within a range from “prioritize noise elimination” to “prioritize FG preservation”, and for the smoothing process, the user can set an arbitrary setting value within a range from “prioritize smoothing” to “prioritize FG preservation”. The setting value for the noise elimination process is correlated with the noise elimination strength such that the noise elimination strength is “0” for the value set to “prioritize FG preservation”, and the noise elimination strength increases as the value approaches “prioritize noise elimination”. The setting value for the smoothing process is correlated with the smoothing strength such that the smoothing strength is “0” for the value set to “prioritize FG preservation”, and the smoothing strength increases as the value approaches “prioritize smoothing”.

When the controller 412 receives a notification from the film determining unit 404 that image data originated from a film source have been input, the controller 412 instructs the noise eliminating unit 402 to change the noise elimination strength, and simultaneously transmits the thus-set noise elimination strength to the noise eliminating unit 402. Furthermore, the controller 412 instructs the smoothing unit 411a to change the smoothing strength, and simultaneously transmits the thus-set smoothing strength to the smoothing unit 411a.

The operation screen described above is displayed on a display device or the like, by a setting information managing unit (not shown in FIG. 1). The setting information managing unit also holds the respective setting values input using the operation screen in a setting information table (not shown in FIG. 1). The controller 412 retrieves necessary setting values from the setting information table, and performs the respective processes and controls described above.

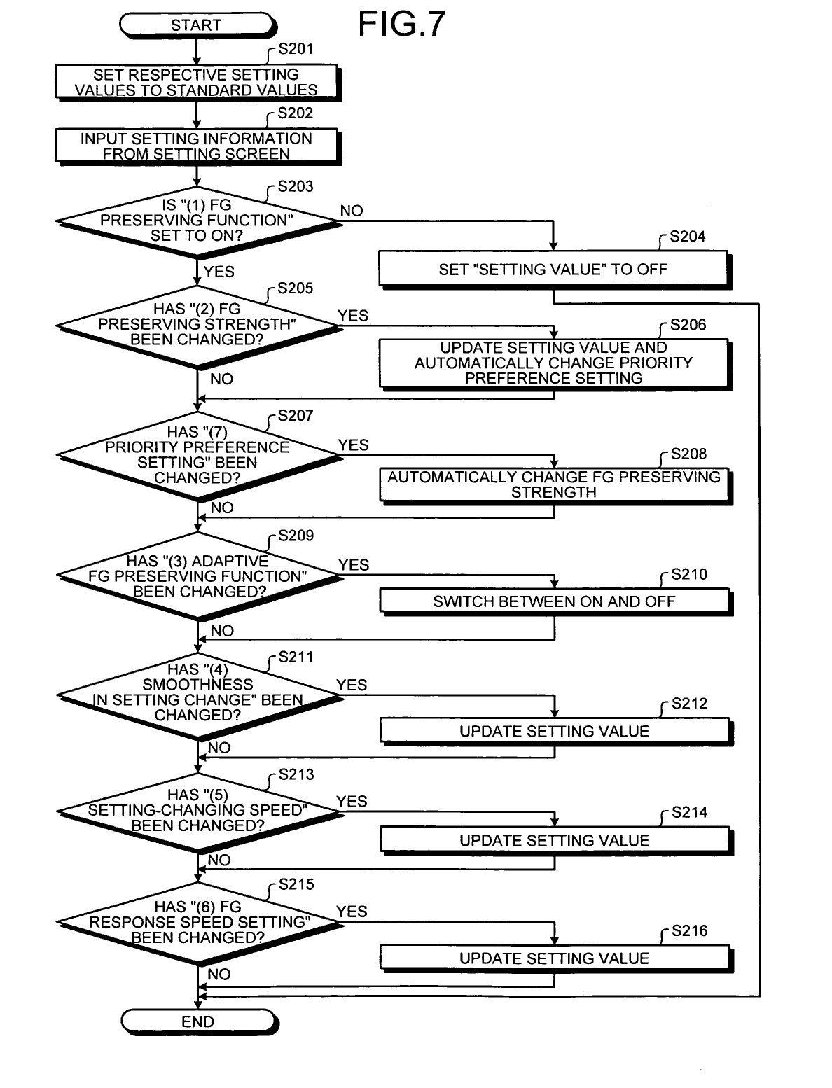

The operation screen and a process procedure performed by the setting information managing unit according to the fourth embodiment will be described. FIG. 7 is a flowchart of the process procedure performed by the setting information managing unit. Upon receipt of a request from the user to change setting information, the setting information managing unit displays the operation screen on the display device and the like, and as shown in FIG. 7, sets the respective setting values to predetermined standard values (step S201).

When various setting information are input by the user (step S202), the setting information managing unit confirms the input setting information for each of the setting items, and updates the setting information table with the thus-confirmed information.

The setting information managing unit confirms whether the setting item on “(1) FG preserving function” is set to ON. When the setting is not set to ON (NO at step S203), the setting information managing unit sets the setting value in the setting information table to OFF (step S204), and terminates the process without updating setting values on the other setting items. On the other hand, when the setting item on “(1) FG preserving function” is set to ON (YES at step S203), the setting information managing unit performs the following processes.

The setting information managing unit confirms whether the setting item on “(2) FG preserving strength” has been changed. When the setting is confirmed to be changed (YES at step S205), the setting information managing unit updates the setting information table with the input setting value, and automatically changes the setting items on “(7) priority preference setting” according to the input setting value (step S206). More specifically, when the setting item on “(2) FG preserving strength” is set to “high (preserve)”, priorities for the noise elimination process and the smoothing process in the setting items on “(7) priority preference setting” are changed to “prioritize FG preservation”. When the setting item on “(2) FG preserving strength” is set to “low (eliminate)”, the priorities for the noise elimination process and the smoothing process in the setting items on “(7) priority preference setting” are changed to “prioritize noise elimination” and “prioritize smoothing”, respectively. On the other hand, when the setting item on “(2) FG preserving strength” has not been changed (NO at step S205), the setting information managing unit does not update the setting information table with the setting value.

The setting information managing unit then confirms whether the setting items on “(7) priority preference setting” have been changed. When the setting items are confirmed to be changed (YES at step S207), the setting information managing unit updates the setting information table with the input setting value, and automatically changes the setting item on “(2) FG preserving strength” (step S208). More specifically, when the priority for the noise elimination process and the smoothing process in the setting items on “(7) priority preference setting” is set to “prioritize FG preservation”, the setting item on “(2) FG preserving strength” is changed to “high (preserve)”, while when the priority for the noise elimination process and the smoothing process in the setting items on “(7) priority preference setting” is set to corresponding one of “prioritize noise elimination” and “prioritize smoothing”, the setting item on “(2) FG preserving strength” is changed to “low (eliminate)”. On the other hand, when the setting items on “(7) priority preference setting” are not changed (NO at step S207), the setting information managing unit does not update the setting information table with the setting value.

The setting information managing unit then confirms whether the setting item on “(3) adaptive FG preserving function” has been changed. When the setting item is confirmed to be changed (YES at step S209), the setting information managing unit switches the setting value to either ON or OFF and updates the setting information table therewith (step S210). On the other hand, when the setting item on “(3) FG adaptive preserving function” has not been changed (NO at step S209), the setting information managing unit does not update the setting information table with the setting value.

The setting information managing unit then confirms whether the setting item on “(4) smoothness in setting change” has been changed. When the setting is confirmed to be changed (YES at step S211), the setting information managing unit updates the setting information table with the input setting value (step S212). On the other hand, when the setting item on “(4) smoothness in setting change” has not been changed (NO at step S211), the setting information managing unit does not update the setting information table with the setting value.

The setting information managing unit then confirms whether the setting item on “(5) setting-changing speed” has been changed. When the setting is confirmed to be changed (YES at step S213), the setting information managing unit updates the setting information table with the input setting value (step S214). On the other hand, when the setting item on “(5) setting-changing speed” has not been changed (NO at step S213), the setting information managing unit does not update the setting information table with the setting value.

The setting information managing unit then confirms whether the setting item on “(6) FG response speed setting” has been changed. When the setting is confirmed to be changed (YES at step S215), the setting information managing unit updates the setting information table with the input setting value (step S216). On the other hand, when the setting item on “(6) FG response speed setting” has not been changed (NO at step S215), the setting information managing unit does not update the setting information table with the setting value.

The order of confirming the respective setting items is not limited to the above order, and the setting items with respect to step S205 and subsequent steps can be confirmed in an arbitrary order.

As described above, in the fourth embodiment, since the user can arbitrarily change the setting information related the respective processes and controls for preserving film grains, images that suit the user's preferences can be displayed. In particular, since the setting-changing time is set by the user, the speed in switching image quality according to changes of image data can be adjusted to meet the user's preference. Furthermore, since the preset response time is set by the user, a response speed during a period from when image data are changed to when image quality has been changed can be adjusted to meet the user's preference.

While the first to fourth embodiments have described about the noise eliminating apparatus, a computer program (hereinafter, “a noise-elimination control program”) can be obtained by embodying a portion of the configuration of the noise eliminating apparatus using software. The noise-elimination control program has the functions performed by the film determining unit 404 and the controller 412 shown in FIG. 1. A computer that executes the noise-elimination control program will be described below.

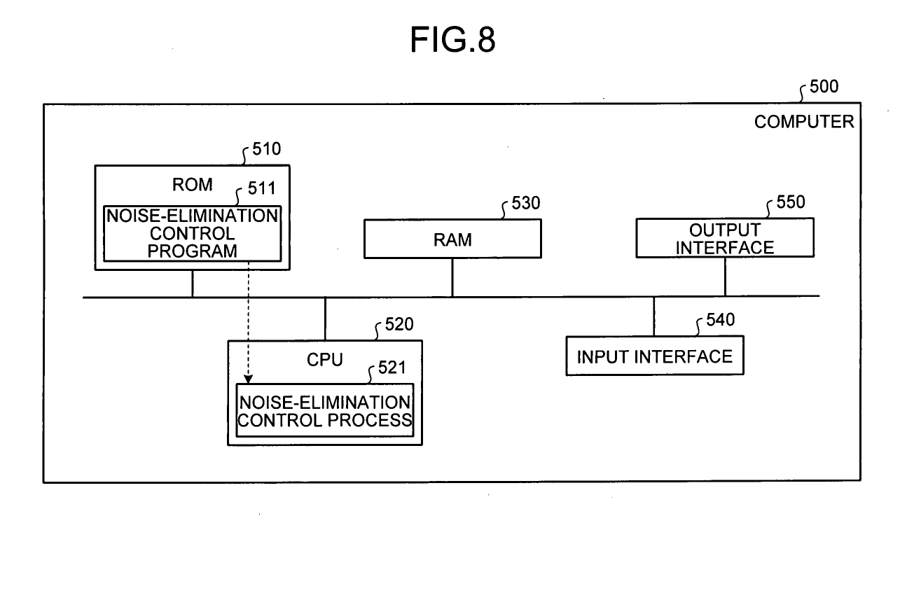

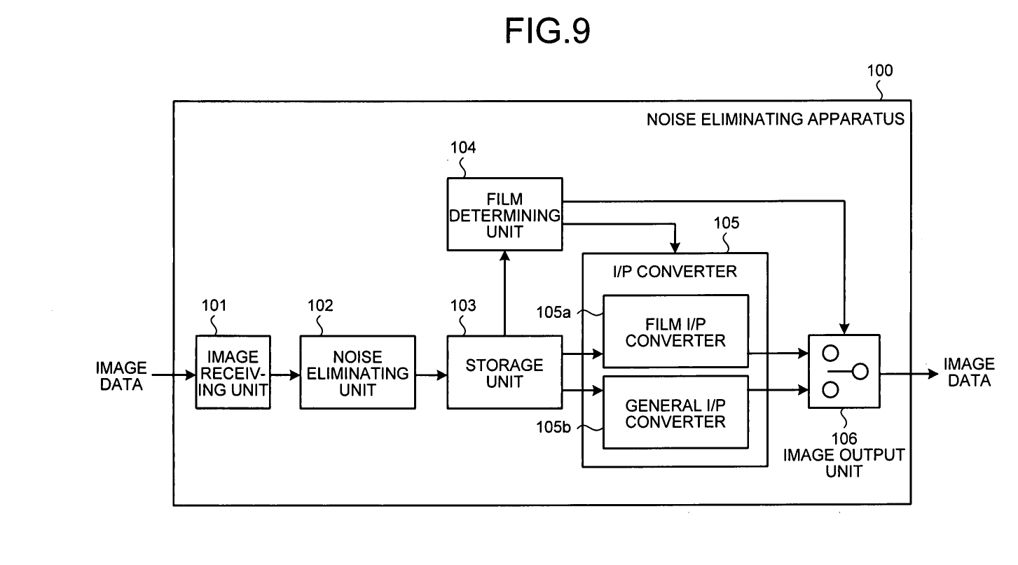

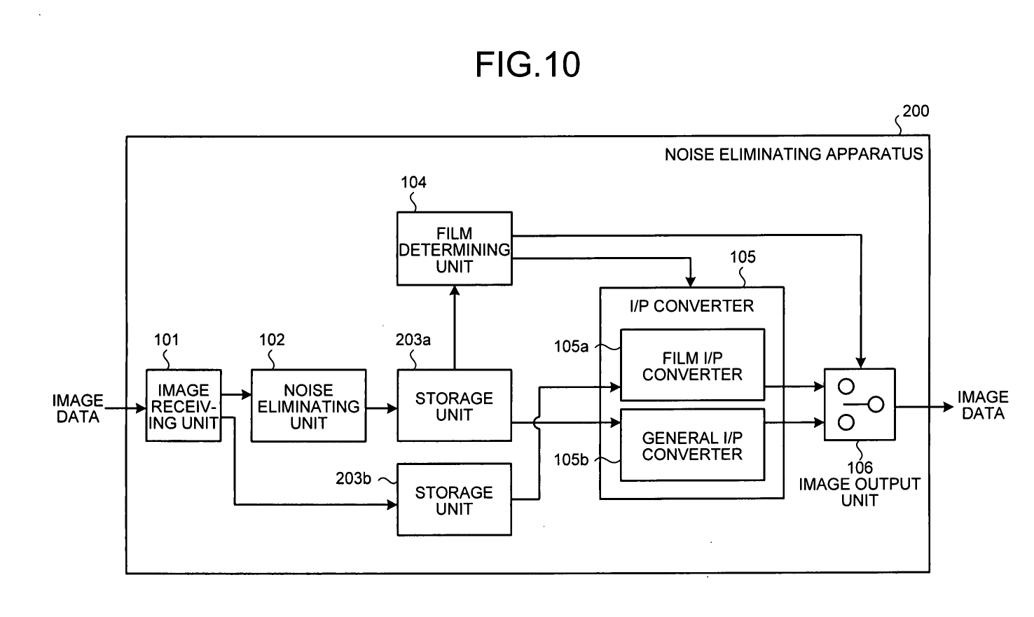

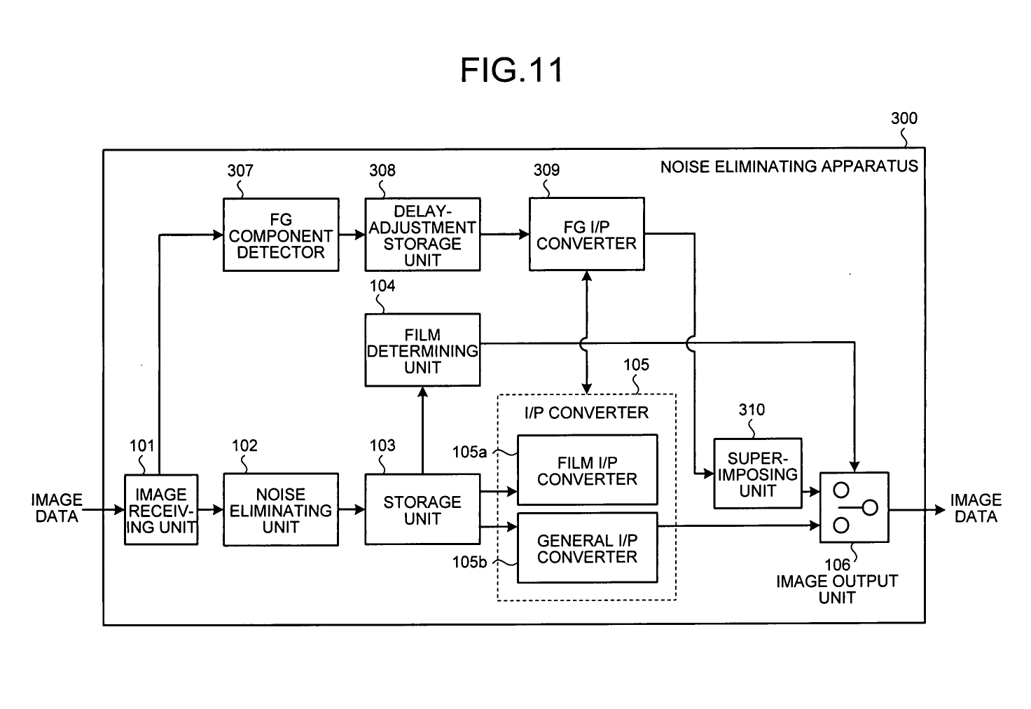

FIG. 8 is a block diagram of a computer 500 that executes the noise-elimination control program according to the first to the fourth embodiments. The computer 500 includes a read only memory (ROM) 510, a central processing unit (CPU) 520, a random access memory (RAM) 530, an input interface 540, and an output interface 550.

The ROM 510 is stores therein data required for executing the noise-elimination control program. The CPU 520 reads the noise-elimination control program from the ROM 510, and executes the noise-elimination control program.

The RAM 530 stores therein data generated along with execution of the noise-elimination control program, input image data, and the like. The RAM 530 corresponds to the storage unit 403 shown in FIG. 1.

The input interface 540 is used for connecting with an input device (not shown) such as an operation panel. The output interface 550 is used for connecting with a display device.

A noise-elimination control program 511 is previously installed in the noise eliminating apparatus, or the like, during manufacturing thereof. The noise-elimination control program 511 is stored in the ROM 510, and executed by the CPU 520 as a noise-elimination control process 521.

Of the respective processing explained in the embodiments, all or a part of the processing explained as being performed automatically can be performed manually, or all or a part of the processing explained as being performed manually can be performed automatically in a known method.

The information including the processing procedure, the control procedure, specific names, and various kinds of data and parameters shown in the data or in the drawing can be optionally changed, unless otherwise specified.

The respective constituents of the illustrated apparatus are functionally conceptual, and the physically same configuration is not always necessary. In other words, the specific mode of dispersion and integration of the apparatus is not limited to the illustrated one, and all or a part thereof may be functionally or physically dispersed or integrated in an optional unit, according to the various kinds of load and the status of use.

According to an aspect of the present invention, the texture of the film images can be preserved with a simple and compact structure.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A noise eliminating apparatus that eliminates noise from input image data, the noise eliminating apparatus comprising:
a film determining unit that determines whether the image data are originated from film recording;
a strength determining unit that determines a strength at which noise is to be eliminated from the image data based on a result of determination made by the film determining unit; and
a noise eliminating unit that eliminates noise from the image data based on the strength determined by the strength determining unit.

2. The noise eliminating apparatus according to claim 1, wherein
when the film determining unit determines that the image data are not oriented from film recording, the strength determining unit determines to eliminate noise from the image data at a predetermined strength, and
when the film determining unit determines that the input image data are originated from film recording, the strength determining unit determines not to eliminate noise from the image data.

3. The noise eliminating apparatus according to claim 1, wherein
when the film determining unit determines that the image data are not originated from film recording, the strength determining unit determines a strength at which noise is to be eliminated from the image data to a first strength, and
when the film determining unit determines that the input image are originated from film recording, the strength determining unit determines the strength at which noise is to be eliminated from the image data to a second strength which is lower than the first strength.

4. The noise eliminating apparatus according to claim 3, wherein
the film determining unit calculates a certainty that indicates a possibility of the image data being originated from film recording; and
the strength determining unit determines the second strength based on the certainty calculated by the film determining unit.

5. The noise eliminating apparatus according to claim 3, wherein, when changing the strength at which noise is to be eliminated from the image data from the first strength to the second strength or from the second strength to the first strength, the strength is gradually changed so that the change from the first strength to the second strength or from the second strength to the first strength is effected over a predetermined setting changing time.

6. The noise eliminating apparatus according to claim 1, wherein, when a result of determination made by the film determining unit does not change within a response time, the strength determining unit determines the strength at which noise is to be eliminated from the image data based on the result of the determination.

7. The noise eliminating apparatus according to claim 4, wherein
a certainty region is divided into a high-certainty region, a low-certainty region, and a medium-certainty region which is positioned between the high-certainty and the low-certainty regions; and
the strength determining unit determines the second strength based on setting information that sets the second strength so that a change rate of the second strength in the medium-certainty region is lower than change rates of the second strength in the high-certainty region and the low-certainty region.

8. The noise eliminating apparatus according to claim 5, further comprising a setting-changing-time setting unit with which a user can set the setting-changing time.

9. The noise eliminating apparatus according to claim 6, further comprising a response-time setting unit with which a user can set the response time.

10. The noise eliminating apparatus according to claim 1, wherein
the strength determining unit further determines a smoothing strength at which the image data are to be smoothed based on a result of determination made by the film determining unit, and
the noise eliminating apparatus further includes a smoothing unit that smoothes the image data based on the smoothing strength determined by the strength determining unit.

11. A method of eliminating noise from input image data, the method comprising:
first determining including determining whether the image data are originated from film recording;
second determining including determining a strength at which noise is to be eliminated from the image data based on a result of determination made at the determining; and
eliminating noise from the image data based on the strength determined at the determining.

12. The method according to claim 11, wherein
when it is determined at the first determining that the image data are not oriented from film recording, the second determining includes determining to eliminate noise from the image data at a predetermined strength, and
when it is determined at the first determining that the input image data are originated from film recording, the second determining includes determining not to eliminate noise from the image data.

13. The method according to claim 11, wherein
when it is determined at the first determining that the image data are not originated from film recording, the second determining includes determining a strength at which noise is to be eliminated from the image data to a first strength, and
when it is determined at the first determining that the input image are originated from film recording, the second determining includes determining the strength at which noise is to be eliminated from the image data to a second strength which is lower than the first strength.

14. The method according to claim 13, wherein
the first determining includes calculating a certainty that indicates a possibility of the image data being originated from film recording; and
the second determining includes determining the second strength based on the certainty calculated at the calculating.

15. The method according to claim 13, wherein, when changing the strength at which noise is to be eliminated from the image data from the first strength to the second strength or from the second strength to the first strength, the strength is gradually changed so that the change from the first strength to the second strength or from the second strength to the first strength is effected over a predetermined setting changing time.

16. The method according to claim 11, wherein, when a result of determination made by at the first determining does not change within a response time, the second determining includes determining the strength at which noise is to be eliminated from the image data based on the result of the determination.

17. The method according to claim 14, wherein
a certainty region is divided into a high-certainty region, a low-certainty region, and a medium-certainty region which is positioned between the high-certainty and the low-certainty regions; and
the second determining includes determining the second strength based on setting information that sets the second strength so that a change rate of the second strength in the medium-certainty region is lower than change rates of the second strength in the high-certainty region and the low-certainty region.

18. The method according to claim 15, further comprising a user setting the setting-changing time.

19. The method according to claim 16, further comprising a user setting the response time.

20. A computer-readable recording medium that stores therein a computer program that causes a computer to eliminates noise from input image data, the computer program causing the computer execute:
determining whether the image data are originated from film recording;
determining a strength at which noise is to be eliminated from the image data based on a result of determination made at the determining; and
eliminating noise from the image data based on the strength determined at the determining.
